(19) United States
(12) Patent Application Publication
(10) Pub. No.: US 2019/0208244 A1
(43) Pub. Date: Jul. 4, 2019

(54) ELECTRONIC APPARATUS AND METHOD FOR CONTROLLING THE SAME

(71) Applicant: Samsung Electronics Co., Ltd., Suwon-si (KR)

(72) Inventors: Ji-woong CHOI, Seoul (KR); Min-soo KIM, Yongin-si (KR); Young-uk KIM, Seoul (KR); Il-koo KIM, Seongnam-si (KR); Hyun-soo CHOI, Seoul (KR); Sung-jin KIM, Yongin-si (KR); Jae-hyun PARK, Seoul (KR)

(21) Appl. No.: 15/970,262

(22) Filed: May 3, 2018

(30) Foreign Application Priority Data
Jan. 4, 2018 (KR) 10-2018-0001344

(51) Int. Cl. H04N 21/262; H04N 21/8405; G06K 9/00; G06F 17/30

(52) U.S. Cl. CPC H04N 21/262; G06F 17/30784; G06K 9/00711; H04N 21/8405

(57) ABSTRACT

An electronic apparatus is provided. The electronic apparatus includes a memory configured to store content schedule information for each content provider, a transceiver and a processor configured to receive content identification information from an external apparatus and time information regarding a time when the content identification information is obtained through the transceiver, identify a content provider corresponding to the content identification information based on the content identification information, the time information and the content schedule information, obtain content schedule information corresponding to the identified content provider from the memory and provide the content schedule information to the external apparatus.

### CROSS-REFERENCE TO RELATED APPLICATION(S)

This application is based on and claims priority under 35 U.S.C. § 119 of a Korean patent application number 10-2018-0001344, filed on Jan. 4, 2018, in the Korean Intellectual Property Office, the disclosure of which is incorporated by reference herein in its entirety.

### BACKGROUND

### 1. Field

The disclosure relates to an electronic apparatus and a method for controlling the same. More particularly, the disclosure relates to an electronic apparatus which provides an external apparatus with content schedule information corresponding to the external apparatus and a method for controlling the same.

### 2. Description of the Related Art

When an image is provided by an electronic device having a display such as a television (TV), content schedule information can be known by using EPG metadata supplied from a content provider according to the related art.

However, in using EPG metadata or other information supplied from a content provider, accurate information may not be obtained. In addition, there is a difficulty in using the information in the electronic device because the format differs for each content provider.

Accordingly, a user can obtain information on a broadcast channel using optical character recognition (OCR) and automatic content recognition (ACR) based on the information displayed on an on screen display (OSD) window to obtain information on a current channel.

However, there is a problem in that only information regarding the current content can be obtained and future content schedule information or past content schedule information cannot be known. Such content schedule information varies significantly depending on each content provider and thus, it is difficult to identify a content provider of an image providing apparatus connected to a specific electronic.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus which receives content identification information from an external apparatus, compares the identification information with content schedule information to identify a content provider corresponding to the external apparatus and provides the external apparatus with content schedule information and a method for controlling the same.

In accordance with an aspect of the disclosure, an electronic apparatus is provided. The electronic apparatus includes a memory configured to store content schedule information for each content provider, a transceiver, and a processor configured to receive content identification information from an external apparatus and time information regarding a time when the content identification information is obtained through the transceiver, identify a content provider corresponding to the content identification information based on the content identification information, the time information and the content schedule information, obtain content schedule information corresponding to the identified content provider from the memory and provide the content schedule information to the external apparatus.

The processor, based on receiving first content identification information and first time information regarding a time when the first content identification information is obtained, may store a content provider list including a plurality of content providers corresponding to the first content identification information based on the content identification information, the first time information and the content schedule information, and based on receiving second content identification information and second time information regarding a time when the second content identification information is obtained, may remove a content provider which does not correspond to the second content identification information from the content provider list based on the second content identification information, the second time information and the content schedule information.

The content identification information may include at least one of keyword information obtained from a content, program name information obtained from the content, or channel information obtained from the content.

The processor may obtain program identification information based on the content identification information, identify content schedule information corresponding to the content identification information and the time information from among content schedule information stored in the memory, and identify a content provider corresponding to the content schedule information as a content provider corresponding to the content identification information.

The processor may match identification information of the external apparatus to identification information of the content provider and stores the matching information in the memory, and based on receiving a content schedule information request signal from the external apparatus, may provide the external apparatus with content schedule information corresponding to the content provider based on the identification information of the matching content provider.

The memory may store at least one of apparatus update information or environment setting information for each of the content provider, and the processor may provide the external apparatus with at least one of update information or environment setting information corresponding to the content provider corresponding to identification information of the external apparatus.

The processor, based on identification information of a content provider matching identification information of the external apparatus not being stored in the memory, may request the external apparatus for the content identification information and time information regarding a time when the content identification information is obtained.

The content identification information may be obtained by analyzing an image signal which is input at the external apparatus through at least one of optical character recognition (OCR) or automatic content recognition (ACR).

The external apparatus may be a display apparatus, and the content provider may be a provider of an image providing apparatus which provides a content to the display apparatus.

In accordance with an aspect of the disclosure, a method for controlling an electronic apparatus which stores content schedule information for each content provider is provided. The method includes receiving content identification information and time information regarding a time when the content identification information is obtained from an external apparatus, identifying a content provider corresponding to the content identification information based on the content identification information, the time information and the content schedule information, and obtaining content schedule information corresponding to the identified content provider from pre-stored identification information and providing the content schedule information to the external apparatus.

The identifying a content provider may include, based on receiving first content identification information and first time information regarding a time when the first content identification information is obtained, storing a content provider list including a plurality of content providers corresponding to the first content identification information based on the first content identification information, the first time information and the content schedule information, and based on receiving second content identification information and second time information regarding a time when the second content identification information is obtained, removing a content provider which does not correspond to the second content identification information from the content provider list based on the second content identification information, the second time information and the content schedule information.

The content identification information may include at least one of keyword information obtained from a content, program name information obtained from the content, or channel information obtained from the content.

The identifying a content provider may include obtaining program identification information based on the content identification information, identifying content schedule information corresponding to the content identification information and the time information from pre-stored content schedule information, and identifying a content provider corresponding to the content schedule information as a content provider corresponding to the content identification information.

The method may further include matching identification information of the external apparatus to identification information of the content provider and storing the matching information, and based on receiving a content schedule information request signal from the external apparatus, providing the external apparatus with content schedule information corresponding to the content provider based on the identification information of the matching content provider.

The providing to an external apparatus may include providing the external apparatus with at least one of update information or environment setting information corresponding to the content provider corresponding to identification information of the external apparatus.

The method may further include, based on identification information of a content provider matching identification information of the external apparatus not being pre-stored, requesting the external apparatus for the content identification information and time information regarding a time when the content identification information is obtained.

The content identification information may be obtained by analyzing an image signal which is input at the external apparatus through at least one of OCR or ACR.

The external apparatus may be a display apparatus, and the content provider may be a provider of an image providing apparatus which provides a content to the display apparatus.

In accordance with another aspect of the disclosure, a non-transitory computer readable recording medium storing a computer instruction to perform an operation of an electronic apparatus when the electronic apparatus storing content schedule information for each content is executed by a processor is provided. The operation includes receiving content identification information and time information regarding a time when the content identification information is obtained from an external apparatus, identifying a content provider corresponding to the content identification information based on the content identification information, the time information and the content schedule information, and obtaining content schedule information corresponding to the identified content provider from pre-stored identification information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view provided to explain a system for controlling an electronic apparatus according to an embodiment of the disclosure;

FIG. 2 is a block diagram of an electronic apparatus according to an embodiment of the disclosure;

FIG. 3 is a view provided to explain an operation of receiving content identification information according to an embodiment of the disclosure;

FIG. 4 is a view provided to explain an operation of receiving content identification information according to an embodiment of the disclosure;

FIG. 5 is a view provided to explain an operation of obtaining content identification information according to an embodiment of the disclosure;

FIG. 6 is a view provided to explain schedule information for providing contents of an electronic apparatus according to an embodiment of the disclosure;

FIGS. 7A and 7B are views provided to explain an operation of generating a content provider list according to various embodiments of the disclosure;

FIG. 8 is a view provided to explain an operation of matching and storing a content provider corresponding to apparatus information according to an embodiment of the disclosure;

FIGS. 9A, 9B, 9C, and 9D are views provided to explain an operation of identifying a content provider according to various embodiments of the disclosure;

FIG. 10 is a flowchart of a controlling method of an electronic apparatus according to an embodiment of the disclosure; and

FIG. 11 is a view specifying a flowchart of a controlling method of an electronic apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before specifically describing the disclosure, a method for demonstrating the disclosure and drawings will be described.

It is to be understood that the generic terms have been chosen for the terms in the specification and claims in view of their functionality in the various embodiments of the disclosure, but such terms may vary depending on the intention of those in the related art, or the legal or technological interpretation and the emergence of new technologies. Also, there may be some terms arbitrarily selected by an applicant. Such terms may be construed according to meanings defined in the present specification, and may also be construed based on general contents of the present specification and a typical technical concept in the art unless the terms are not specifically defined.

The same reference numerals or symbols described in the attached drawings denote parts or elements that actually perform the same functions. For convenience of descriptions and understanding, the same reference numerals or symbols are used and described in different various embodiments. In other words, although elements having the same reference numerals are all illustrated in a plurality of drawings, the plurality of drawings do not mean one embodiment.

In addition, in order to distinguish between the components, terms including an ordinal number such as “first”, “second”, etc. may be used in the present specification and claims. The ordinal numbers are used in order to distinguish the same or similar elements from one another, and the use of the ordinal number should not be understood as limiting the meaning of the terms. For example, orders, arrangement orders, or the like of elements that are combined with these ordinal numbers may not be limited by the numbers. The respective ordinal numbers are interchangeably used, if necessary.

The singular expression also includes the plural meaning as long as it does not differently mean in the context. The terms “comprise”, “is configured to,” etc., of the description are used to indicate that there are features, numbers, operations, elements, parts or combination thereof, and they should not exclude the possibilities of combination or addition of one or more features, numbers, operations, elements, parts or a combination thereof.

Various embodiments may have a variety of modifications and several embodiments. Accordingly, specific various embodiments will be illustrated in the drawings and described in detail in the detailed description. However, this does not necessarily limit the scope of the various embodiments to a specific embodiment form. Instead, modifications, equivalents and replacements included in the disclosed concept and technical scope of this specification may be employed. While describing various embodiments, if it is determined that the specific description regarding a known technology obscures the gist of the disclosure, the specific description is omitted.

The terms such as “first,” “second,” and so on may be used to describe a variety of elements, but the elements should not be limited by these terms. The terms used herein are solely intended to explain specific example embodiments, and not to limit the scope of the disclosure.

The terms used herein are solely intended to explain a specific embodiment, and not to limit the scope of the disclosure. Singular forms are intended to include plural forms unless the context clearly indicates otherwise. The terms “comprise”, “is configured to,” etc., of the description are used to indicate that there are features, numbers, operations, elements, parts or combination thereof, and they should not exclude the possibilities of combination or addition of one or more features, numbers, operations, elements, parts or a combination thereof.

In the embodiment of the disclosure, the term “module,” “unit,” or “part” is referred to as an element that performs at least one function or operation, and may be implemented with hardware, software, or a combination of hardware and software. In addition, a plurality of “modules,” a plurality of “units,” a plurality of “parts” may be integrated into at least one module or chip except for a “module,” a “unit,” or a “part” which has to be implemented with specific hardware, and may be implemented with at least one processor.

Also, when any part is connected to another part, this includes a direct connection and an indirect connection through another medium. Further, when a certain portion includes a certain element, unless specified to the contrary, this means that another element may be additionally included, rather than precluding another element.

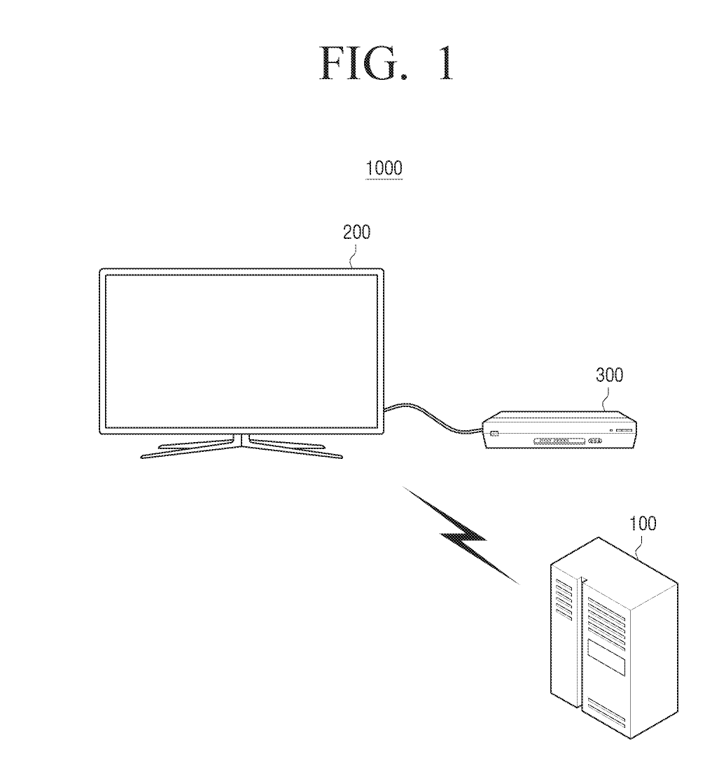

FIG. 1 is a view provided to explain a system 1000 for controlling an electronic apparatus according to an embodiment of the disclosure.

Referring to FIG. 1, an electronic apparatus 100 may confirm a content provider matching an external apparatus 200 by analyzing identification information of the external apparatus 200.

Here, the electronic apparatus 100 may be a server including a device with a large scale storage space.

The external apparatus 200 may be an electronic apparatus which receives an image signal, and may be an electronic apparatus having a display as a component. For example, the external apparatus 200 may be an image displaying apparatus having a display, such as a television (TV), a smart phone, a tablet, etc.

Meanwhile, the external apparatus 200 according to another embodiment may be an apparatus which does not include a display. In this case, the external apparatus 200 may transmit an image signal to a separate apparatus which includes a display. In other words, the external apparatus 200 may be an apparatus which receives information regarding an image signal and transmits the information to apparatus including a display.

An image providing apparatus 300 may transmit information regarding a content to the external apparatus 200. In this case, the image providing apparatus 300 may vary depending on content providers, and different image providing apparatuses may transmit information on different contents to the external apparatus 200. For example, the image providing apparatus 300 may be a set-top-box (STB), etc.

Meanwhile, in the above embodiment, the external apparatus 200 and the image providing apparatus 300 are distinguished from each other, but in the actual embodiment, the external apparatus 200 may perform the same functions as the image providing apparatus 300. In other words, the external apparatus 200 may not have a separate display, receive an image signal directly from a content provider and transmit the image signal to a separate apparatus with a display.

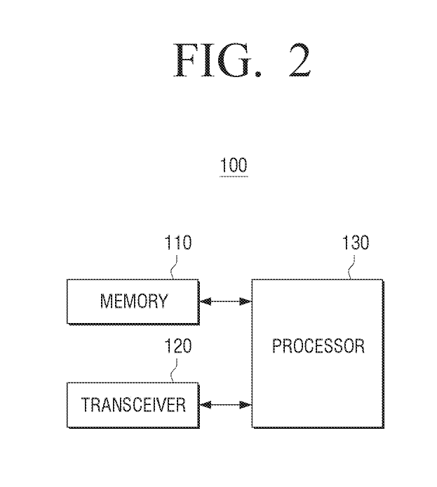

FIG. 2 is a block diagram of an electronic apparatus according to an embodiment of the disclosure.

Referring to FIG. 2, the electronic apparatus 100 may consist of a memory 110, a communicator 120 and a processor 130.

The memory 110 is a space for storing data. The memory 110 may store information on a content provider matching the specific external apparatus 200 and information on content schedule for each content provider.

In addition, the memory 110 may store various application programs, data, software modules for driving and controlling the electronic apparatus 100 under the control of the processor 120. For example, the memory 110 may include a content information storage/analysis module for storing identification information and history information of contents provided by the electronic apparatus 100, a curator module for selecting preferred contents, a content exposure module for providing information on selected preferred contents, a voice recognition module, an image recognition module, etc.

The content identification information may include at least one of keyword information obtained from contents, program name information obtained from the contents, or channel information obtained from the contents.

Meanwhile, the history information of contents may include, for example, on/off time of the electronic apparatus 100, content use history, input information (remote controller, voice, etc.), function use history (menu selection history, etc.), etc. The memory 110 may store history information for each day and time regarding each of at least one content provided by the electronic apparatus 100. The memory 110 may store history information for day only or for time only. Specifically, the history information may include information regarding when (date and time) a specific content was used and how long (use time) the content was used. The history information may be updated by adding new history as a user uses contents.

Here, the contents may be, for example, a broadcast channel and a broadcast content (e.g., video on demand (VoD), streaming contents (images, music, etc.)), or a plurality of applications, functions, etc. which can be executed in the electronic apparatus 100. In other words, the history information may include, for example, information regarding when a specific broadcast channel was watched and how long the specific channel was watched, and information regarding when a specific content was reproduced and how long the specific content was reproduced. However, this is only an example, and various history information may be stored in the memory 110 depending on which contents the electronic apparatus 100 provides.

The memory 110 may be implemented as a non-volatile memory, a volatile memory, a flash memory, a hard disk drive (HDD), or a solid state drive (SSD). Meanwhile, the memory 110 may be implemented not only as a storage medium inside the electronic apparatus 100 but also as an external storage medium such as a micro secure digital (SD) card, a universal serial bus (USB) memory card, a web server through a network, etc.

The communicator 120 (e.g. transceiver) may exchange data with the external apparatus 200 through a communication session connected in a wired or wireless manner. The operations of receiving content identification information from the external apparatus 200 and providing content schedule information to the external apparatus 200 may be controlled by the processor 130 which will be described later.

The processor 130 controls overall operations of the electronic apparatus 100.

The processor 130 according to an embodiment may include one or more of digital signal processor (DSP), microprocessor, time controller (TCON), central processing unit (CPU), micro controller unit (MCU), micro processing unit (MPU), controller, application processor (AP), communication processor (CP), and ARM processor, or may be defined in the corresponding term. In addition, the processor 130 may be implemented as system on chip (SoC) or large scale integration (LSI) with a built-in processing algorithm, or in the form of field programmable gate array (FPGA).

If identification information matching the identification information of the external apparatus 200 is stored in the memory 110, the processor 130 may not request content identification information and time information regarding a time when the content identification information is obtained to the external apparatus 200, and control the communicator 120 to transmit content schedule information corresponding to a matching content provider directly.

Meanwhile, if identification information of a content provider matching the identification information of the external apparatus 200 is not stored in the memory 110, the processor 130 may request content identification information and time information regarding a time when the content identification information is obtained to the external apparatus 200.

Alternatively, the processor may receive content identification information and time information regarding a time when the content identification information is obtained from the external apparatus 200 through the communicator 120, identify a content provider corresponding to the content identification information based on the content identification information, the time information and the content schedule information, obtain content schedule information corresponding to the identified content provider from the memory 110, and provide the content schedule information to the external apparatus 200.

Meanwhile, the time information may be received from the external apparatus 200, but in the actual embodiment, the time information measured in the electronic apparatus 100 may be used. In other words, if content identification information is transmitted directly from the external apparatus 200 to the electronic apparatus 100, it may not be a problem to obtain the time information from the electronic apparatus 100.

Meanwhile, the content identification information may include at least one of keyword information obtained from a content, program name information obtained from the content, or channel information obtained from the content.

In addition, the content identification information may be a text, logo or a trademark included in an image which is input at the external apparatus 200.

Further, the content identification information may be obtained by analyzing an image signal which is input at the external apparatus 200 through at least one of optical character recognition (OCR) or automatic content recognition (ACR).

Meanwhile, in this case, the external apparatus 200 may apply OCR or ACR only to a specific location in order to analyze an image signal input at the external apparatus 200 swiftly. For example, the processor 130 may analyze content identification information only for the location of an on screen display (OSD) window or the upper right, upper left or lower end of an image frame. However, the location is not limited to a specific part, and the entire image frame may be analyzed according to a user setting. Also, the case of analyzing only a specific part may be changed by a user setting.

If the external apparatus 200 analyzes only a specific part of an image frame, the processing speed may be faster than when the external apparatus 200 analyzes the entire image frame.

Meanwhile, in the above embodiment, the operation of analyzing content identification information is performed by the external apparatus 200, but according to another embodiment, the operation may be performed by the processor 130 of the electronic apparatus 100.

Meanwhile, a content provider may be a provider of the image providing apparatus 200 which provides a content to the external apparatus 200. Specifically, a content provider may be a cable provider or an IPTV provider who provides contents, and a content provider may be a service provider who provides a plurality of channels or contents. The content provider may be different according to the image providing apparatus 300.

Meanwhile, if identification information of a content provider matching the identification information of the external apparatus 200 is not stored in the memory 110, the processor 130 may request content identification information and time information regarding a time when the content identification information is obtained to the external apparatus 200, and the processor 130 may repeat the operation of receiving and analyzing the content identification information.

In this case, if first content identification information and first time information regarding a time when the first identification information is obtained is received from the external apparatus 200, the processor 130 may identify a plurality of content providers corresponding to the first content identification information based on the first content identification information and first time information and pre-stored content schedule information, and store a content provider list including the plurality of identified content providers in the memory 110.

Subsequently, if second content identification information and second time information regarding a time when the second identification information is obtained is received from the external apparatus 200, the processor 130 may delete a content provider who does not correspond to the second content identification information from a content provider list.

Specifically, the processor 130 may identify a content which is currently provided to the external apparatus 200 based on the content identification information received from the external apparatus 200. For example, if the content identification information received from the external apparatus 200 is a keyword provided a specific program, the processor 130 may obtain a program name currently provided to the external apparatus 200 based on the corresponding keyword. Subsequently, the processor 130 may compare the corresponding program name with content schedule information and identify a content provider related to the external apparatus 200.

In this case, the processor 130 may identify a content provider by using information regarding a time when the content identification information is obtained. In other words, the processor 130 may filter and store a content provider based on a program name first, and then may filter and store a content provider based on a time when the content is obtained, that is, a content broadcast time.

For example, even though the number of content providers who provide a currently-identified content (for example, a program name), there may be three content providers who provide the corresponding program at the time when the content identification information is obtained, in other words, at the time when the corresponding program is broadcast at the external apparatus 200.

The processor 130 may repeat the operation of removing the above-described content provide from the content provider list. The processor 130 may repeat the operation of obtaining program identification information based on the content identification information, identifying content schedule information corresponding to the content identification information and the time information among the content schedule information stored in the memory 110, and removing the content provider who does not correspond to the content identification information from the content provider list until one content provider is left in the content provider list.

When only one of the content providers included in the content provider list is left, the processor 130 may identify the content provider corresponding to the content schedule information as a content provider corresponding to the content identification information.

In addition, the processor 130 may match the identification information of the content provider to the identification information of the external apparatus 200. The processor 130 may match the identification information of the external apparatus 200 to the identification information of the content provider and store the same in the memory 110, and if a signal to request content schedule information is received from the external apparatus 200, the content schedule information corresponding to a content provider based on identification information of the matching content provider may be provided to the external apparatus 200.

In the above description of an embodiment, the processor 130 provides the external apparatus 200 with the content schedule information, but the processor 130 may provide the external apparatus 200 with at least one of the above-described update information or environment setting information instead of the content schedule information. The update and environment setting information of the electronic apparatus 100 may vary depending on content providers. The processor 130 may identify a content provider corresponding to the external apparatus 200, and provide the external apparatus 200 with specific update and environment setting information of the content provider matching the external apparatus 200. Here, the update information may be various software upgrade information for receiving and displaying image signals provided by the specific image providing apparatus 200 and the content provider. The environment setting information may be environment setting information of the electronic apparatus 100 for providing a user with an image signal supplied from the specific image providing apparatus 300 and the content provider efficiently or with the optimum quality.

As such, the electronic apparatus 100 according to an embodiment may identify a content provider corresponding to the external apparatus 200 and thus, figure out content schedule information corresponding to the content provider. In addition, the electronic apparatus 100 may identify content information not only at the present time but also in the future using the content schedule information corresponding to the content provider and thus, may predict a content to be provided to the external apparatus 200 in advance.

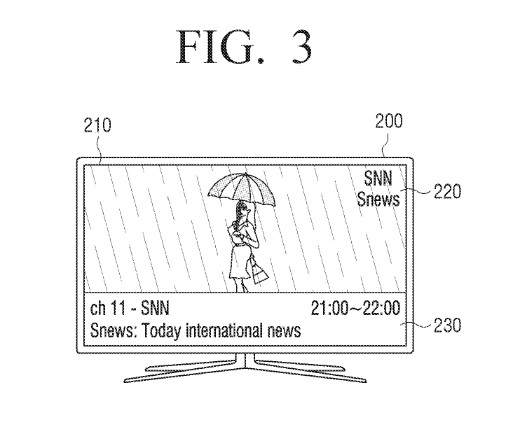

FIG. 3 is a view provided to explain an operation of receiving content identification information according to an embodiment of the disclosure.

Referring to FIG. 3, the external apparatus 200 may receive an image, and content identification information may be obtained using the image received from the external apparatus 200. The content identification information may be obtained by analyzing an image signal input at the external apparatus 200 through at least one of OCR or ACR.

Specifically, if an image 210 of broadcasting a specific program is received at the external apparatus 200, the external apparatus 200 may analyze the image 210 at predetermined time intervals. In general, if a user changes a channel, an OSD window 230 appears and various information such as channel number, channel name, program contents, program time, etc. may be displayed on the OSD window. Accordingly, the external apparatus 200 may obtain content identification information from the OSD window 230.

Meanwhile, information regarding a broadcaster and program may be obtained from an upper right part 220 in addition to the OSD window 230.

In this case, the external apparatus 200 may analyze the entire part of the image 210 in order to obtain the content identification information. In addition, the external apparatus 200 may analyze only specific parts such as the OSD window 230 and the upper right part 220 in order to obtain the content identification information. When the external apparatus 200 limits specific parts and analyze only the limited parts, the processing speed may be improved in comparison with the case where the entire parts are analyzed.

The above description regarding the operation of FIG. 3 is limited to the part of the OSD window 230 and the upper right part 220, but it may be changed according to a user setting.

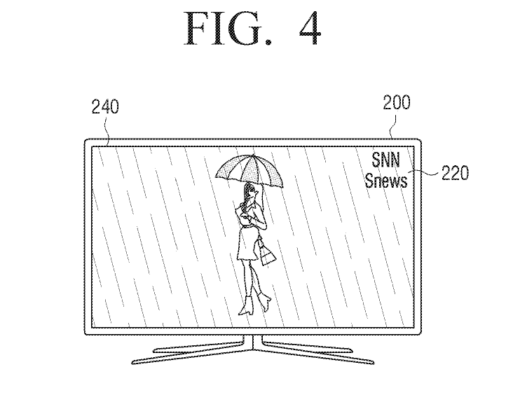

FIG. 4 is a view provided to explain an operation of receiving content identification information according to another embodiment of the disclosure.

Referring to FIG. 4, another image 240 may be provided to the external apparatus 200 after the image 210 of FIG. 3 is provided. Meanwhile, a channel name and a program name may also be provided on the upper right part 220 of the new image 240.

The external apparatus 200 may also obtain content identification information in the new image 240, but the amount of contents may be smaller than that of FIG. 3. Accordingly, it may be more efficient that the external apparatus 200 performs the operation of obtaining content identification information only when the OSD window 230 is displayed.

However, even though the OSD window 230 is not displayed, an image received at the external apparatus 200 may be analyzed at predetermined time intervals. The electronic apparatus 100 may obtain content identification information from the analyzed image.

Meanwhile, in the above description regarding FIGS. 3 and 4, the external apparatus 200 analyzes an image, but in the actual embodiment, the external apparatus 200 may transmit information regarding an image to the electronic apparatus 100, and the electronic apparatus 10 may analyze the image and obtain content identification information.

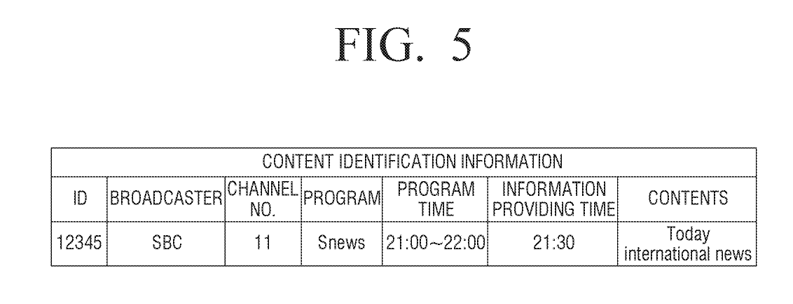

FIG. 5 is a view provided to explain an operation of obtaining content identification information according to an embodiment of the disclosure.

Referring to FIG. 5, the content identification information may be arranged based on the ID of the external apparatus 200, and may include at least one of broadcaster, channel number, program name, program time, time for providing content identification information or other content information.

Here, the other content information may be description information regarding a program displayed on the OSD window.

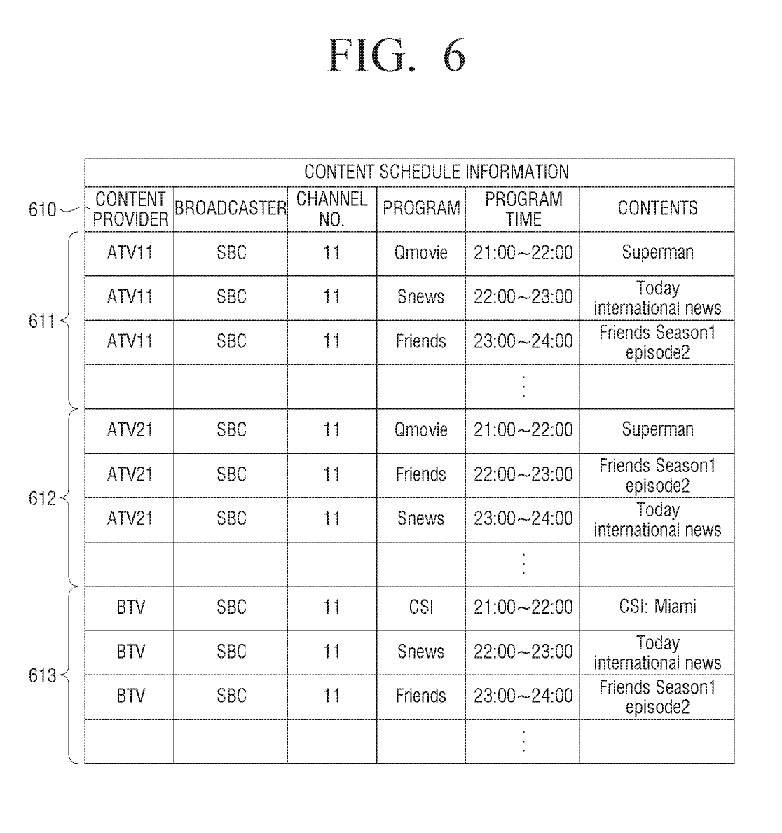

FIG. 6 is a view provided to explain schedule information for providing contents of an electronic apparatus according to an embodiment of the disclosure.

Referring to FIG. 6, the content schedule information may be stored in the electronic apparatus 100. The content schedule information may include at least one of broadcaster, channel number, program name, program time, or other content information.

A content provider 610 may be a plurality of content providers such as 611, 612, 613, and may be categorized according to each content provider, consisting of content schedule information.

Meanwhile, in the description regarding FIG. 6, only SBC broadcaster corresponding to channel number 11 is included in the content schedule information, but in the actual embodiment, content information regarding various broadcasters may be included in the content schedule information.

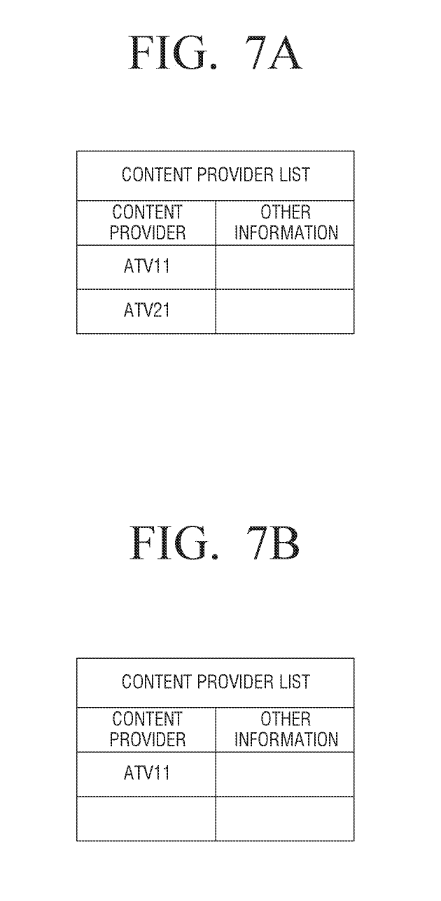

FIG. 7A is a view provided to explain an operation of generating a content provider list according to an embodiment of the disclosure.

Referring to FIG. 7A, it is assumed that the present time is 21:30, and the program of ‘Qmovie’ from SBC broadcaster is currently provided to the external apparatus 200.

If a user selects channel 11 (SBC broadcaster), specific information regarding the program provided by the selected channel may be displayed on the OSD window. The external apparatus 200 may analyze the information displayed on the OSD window to obtain content identification information and transmit the obtained content identification information to the electronic apparatus 100.

The electronic apparatus 100 may compare the information regarding the received content identification information with the content schedule information. By using the time information (21:30) received from the external apparatus 200, the electronic apparatus 100 may identify a content provider which provides ‘Qmovie’ of SBC broadcaster at the present time (21:30). Referring to FIG. 6, the electronic apparatus 100 may identify the content provider which provides ‘Qmovie’ at SBC broadcaster as ATV11 and ATV21.

The electronic apparatus 100 may predict that the content provider which provides a content to the external apparatus 200 would be one of ATV11 and ATV21, and generate and store a content provider list.

In this case, since there are two content providers which provide contents to the external apparatus 200, the electronic apparatus 100 may generate a content provider list and wait for the next analysis without specifying a content provider matching the external apparatus 200.

It is assumed that the present time is 22:30, and the image provided to the external apparatus 200 is about Snews. If a user selects channel 11 at 22:30, the external apparatus 200 may obtain content identification information by analyzing specific information displayed on the OSD window or on the image.

The electronic apparatus 100 may identify that the program currently provided to the external apparatus 200 is Snews through the obtained information, and the electronic apparatus 100 may compare the content identification information with the content schedule information. Referring to the content schedule information illustrated in FIG. 6, the content providers which may provide Snews at 22:30 are ATV11 and BTV.

The electronic apparatus 100 may compare the newly identified content providers ATV11, BTV with those in the pre-generated content provider list, and identify a content providers which are not consistent with those in the pre-generated content provider list. And, the electronic apparatus 100 may remove the content providers on the pre-generated content provider list based on the content providers being in the pre-generated content provider list. The electronic apparatus 100 may maintain the pre-generated content provider list based on the content providers not being in the pre-generated content provider list.

FIG. 7B is a view provided to explain an operation of generating a content provider list according to an embodiment of the disclosure.

Referring to FIG. 7B, since the pre-generated content provider list (FIG. 7A) includes only ATV 11 and ATV 21, when the operation of removing the newly identified content providers ATV 11, BTV is performed, only ATV11 may be left in the content provider list.

In other words, the electronic apparatus 100 may remove the content provider which is not consistent with the newly identified content provider from the content providers included in the content provider list.

Referring to FIG. 7B, since one content provider is left I the content provider list, a content provider corresponding to the external apparatus 200 can be matched.

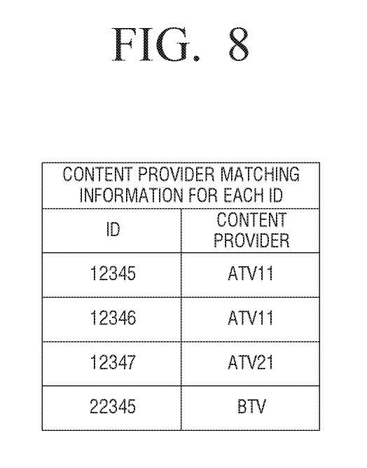

FIG. 8 is a view provided to explain an operation of matching and storing a content provider corresponding to apparatus information according to an embodiment of the disclosure.

Referring to FIG. 8, the electronic apparatus 100 may identify a content provider matching a variety of external apparatuses 200, and store matching content providers based on the ID of the external apparatus 200.

If the content provider of the external apparatus 200 needs to be identified according to a user request or a predetermined event, the electronic apparatus 100 may use the above-described matching information.

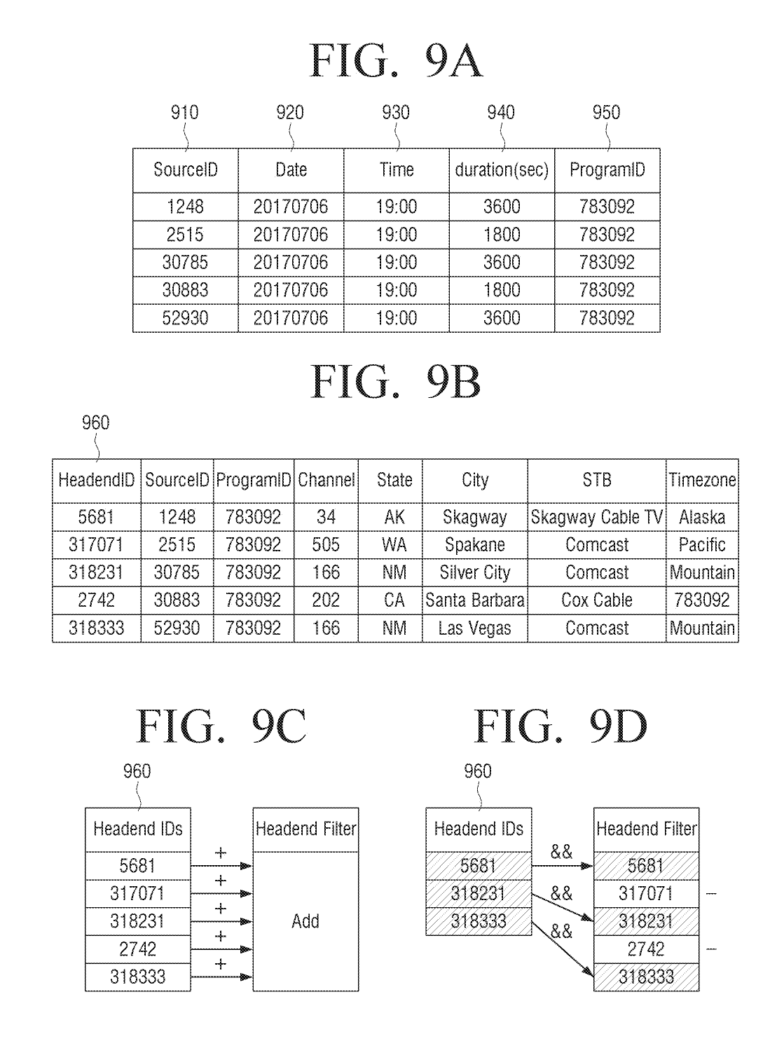

FIG. 9A is a view provided to explain an operation of identifying a content provider according to an embodiment of the disclosure.

Referring to FIG. 9A, the content schedule information may include at least one of source ID 910, date information 920, time information 930, duration information 940, or program ID 950.

Here, the source ID 910 may be a unique ID of the content provided by the current channel, and even if the program ID 950 is the same, the source ID 920 may be different according to the content provider and the content providing time.

Meanwhile, the time information 930 may indicate the start time of the program, and the end time may be identified by reflecting the duration information 940. For example, considering the time information of 19:00 and the duration information of 3,600 seconds, you can see that the program is broadcast from 19:00 to 20:00.

FIG. 9B is a view provided to explain an operation of identifying a content provider according to an embodiment of the disclosure.

Referring to FIG. 9B, the content schedule information may further include headend ID 960. The headend ID 960 may be the identification information of a content provider.

It is assumed that the present time is 19:15, and the program provided by the external apparatus 200 is identified as ‘783092.’ The electronic apparatus 100 may search all content providers capable of providing a program corresponding to ‘783092.’ In this case, five content providers may be identified.

FIG. 9C is a view provided to explain an operation of identifying a content provider according to an embodiment of the disclosure.

Referring to FIG. 9C, when five content providers are identified, the electronic apparatus 100 may generate and add a content provider list. The content provider list may be represented as ‘a headend filter.’

It is assumed that content identification information obtained at 19:45, which is 30 minutes after the analysis of the content identification information acquired at 19:15. In this case, source IDs 2515 and 30883 have a duration of 1,800 seconds, the program 783092 is not broadcast at 19:45. Accordingly, the content provider identified at 19:45 may correspond to 5681, 318231, 318333.

FIG. 9D is a view provided to explain an operation of identifying a content provider according to an embodiment of the disclosure.

Referring to FIG. 9D, among five content providers included in the content provider list, the content providers 317071, 2747 which are not consistent with the content provider identified at 19:45 may be removed from the existing content provider list.

If the above process is repeated, one content provider will eventually remain in the content provider list, and the electronic apparatus 100 may match the one remaining content provider with the external apparatus 200.

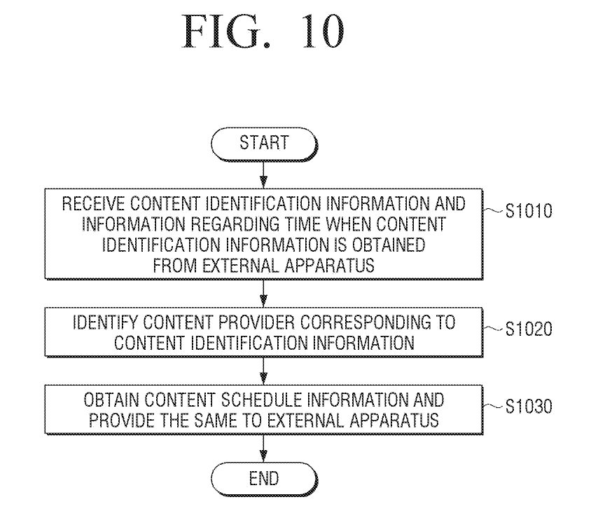

FIG. 10 is a flowchart of a controlling method of an electronic apparatus according to an embodiment of the disclosure.

Referring to FIG. 10, the controlling method of the electronic apparatus 100 which stores content schedule information for each content provider according to an embodiment may comprise receiving content identification information and time information regarding a time when the content identification information is received from the external apparatus 200 at operation S1010. A content provider corresponding to the content identification information may be identified based on the content identification information, the time information and content schedule information at operation S1020. The content schedule information corresponding to the identified content provider among pre-stored information may be acquired and provided to the external apparatus at operation S1030.

In this case, the content identification information may include at least one of keyword information obtained from the content, program name information obtained from the content, or channel information obtained from the content.

The content identification information may be obtained by analyzing an image signal input at the external apparatus 200 through at least one of OCR or ACR.

The external apparatus 200 may be a display apparatus, and the content provider may be a provider of the image providing apparatus 300 which provides contents to a display apparatus.

Meanwhile, in the operation of S1020, when the first content identification information and the first time information regarding the time when the first content identification information is obtained is received from the external apparatus 200, a content provider list including a plurality of content providers corresponding to the first content identification information may be stored based on the first content identification information, the first time information and the content schedule information, and when the second content identification information and the second time information regarding the time when the second content identification information is obtained is received from the external apparatus 200, a content provider which does not correspond to the second content identification information may be removed from the content provider list based on the second content identification information, the second time information and the content schedule information.

In addition, at operation S1020 program identification information may be obtained based on the content identification information, content schedule information corresponding to the content identification information and the time information among pre-stored content schedule information may be identified, and a content provider corresponding to the content schedule information may be identified as a content provider corresponding to the content identification information.

The operation of matching the identification information of the external apparatus 200 with the identification information of a content provider and storing the same, and the operation of, when a signal for requesting content schedule information is received from the external apparatus 200, providing content schedule information corresponding to the content provider to the external apparatus 200 based on the identification information of the matching content provider may be further included. In this case, the operation of providing to the external apparatus 200 may comprise at least one of update information or environment setting information corresponding to the content provider corresponding to the identification of the external apparatus 200.

If the identification information of the content provider matching the identification information of the external apparatus 200 is not pre-stored, the operation of requesting the content identification information and information regarding the time when the content identification information is obtained may be further included.

Meanwhile, the controlling method of an electronic apparatus in FIG. 10 may be executed in an electronic apparatus having the configuration of FIG. 2 and may also be executed in an electronic apparatus having other configuration.

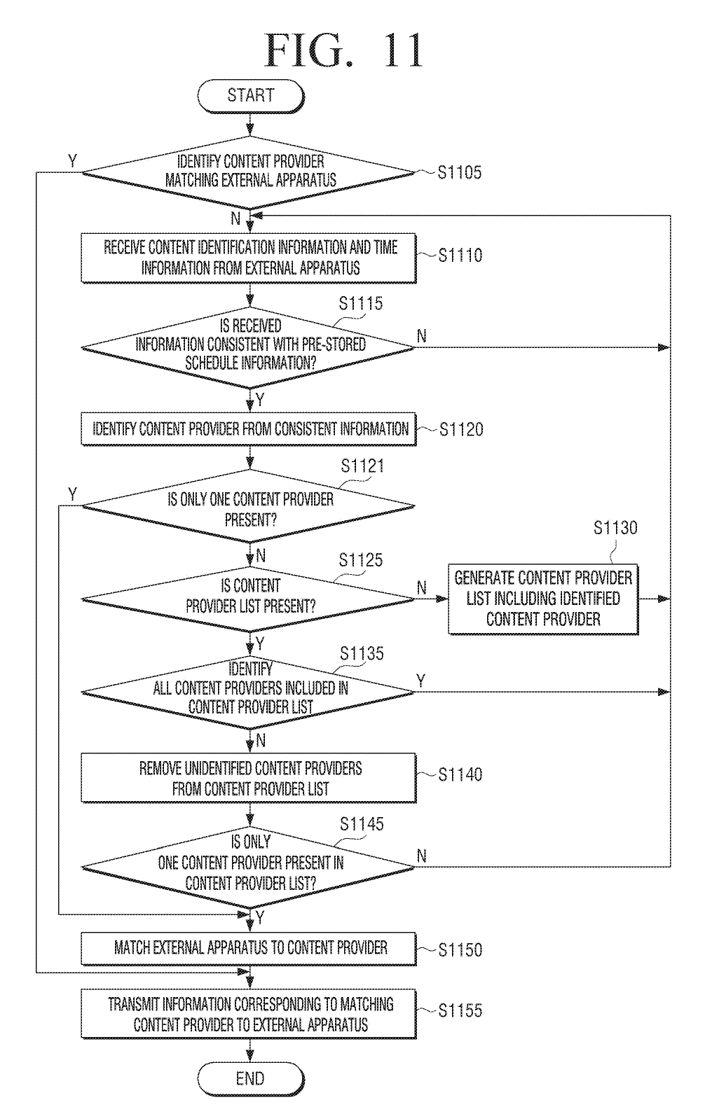

FIG. 11 is a view specifying a flowchart of a controlling method of the electronic apparatus of FIG. 10 according to an embodiment of the disclosure.

Referring to FIG. 11, the electronic apparatus 100 may identify a content provider matching the external apparatus 200 at operation S1105.

In this case, if there is a content provider matching the external apparatus 200, the electronic apparatus 100 may transmit information corresponding to the content provider matching the external apparatus 200 to the external apparatus 200 at operation S1155. In this case, the transmitted information may be content schedule information, update information or environment setting information.

Meanwhile, if there is no content provider matching the external apparatus 200, the electronic apparatus 10 may receive the content identification information and the time information from the external apparatus 200 at operation S1110. In this case, the time information may be provided by the eternal apparatus 200 or may be obtained from the electronic apparatus 100.

The electronic apparatus 100 may determine whether there is information which is consistent with the content schedule information based on the received content identification information and time information at operation S1115. In this case, if there is no information which is consistent with the pre-stored content schedule information, the operation of receiving new content identification information and time information at operation S1110 may be performed.

Meanwhile, if there is information which is consistent with the pre-stored content schedule information a content provider may be identified from the consistent information at operation S1120.

The electronic apparatus 100 may determine whether there is one identified content provider at operation S1121. Here, if the number of identified content provider is one, the electronic apparatus 100 may match the external apparatus 200 to the identified content provider at operation S1150.

However, if there are two or more identified content providers, the electronic apparatus 100 may identify whether there is a content provider list at operation S1125. If there is no content provider list, the electronic apparatus 100 may newly generate a content provider list including the identified content providers at operation S1130.

Alternatively, if there is a content provider list, the electronic apparatus 100 may confirm whether all of the content providers included in the content provider list are identified in the operation of S1120 at operation S1135. Specifically, if all of the content providers included in the content provider list are identified in a recent analysis process, the electronic apparatus 100 may perform the operation of S1110 without any separate operation. However, if not all of the content providers included in the content provider list are identified in a recent analysis process, the electronic apparatus 100 may remove the unidentified content providers from among the content providers included in the content provider list in the operation of S1120 at operation S1140.

The electronic apparatus 100 may confirm whether there is one content provider left in the content provider list at operation S1145. If there are two or more content providers left in the content provider list, the electronic apparatus 100 may perform the operation of S1110.

Meanwhile, if there is one content provider left in the content provider list, the electronic apparatus 100 may match the external apparatus 200 to the content provider left in the content provider list at operation S1150.

Subsequently, the electronic apparatus 100 may transmit information corresponding to the matching content provider to the external apparatus 200 at operation S1155.

Meanwhile, the controlling method of an electronic apparatus according to an embodiment may be implemented as a program and provided to the electronic apparatus. In particular, the program including the controlling method of an electronic apparatus may be stored in a non-transitory computer readable medium and provided.

Meanwhile, in a non-transitory computer readable recording medium storing a computer instruction to perform an operation of an electronic apparatus based on the electronic apparatus storing content schedule information for each content being executed by a processor, the operations include receiving content identification information and time information regarding a time when the content identification information is obtained from the external apparatus 200, identifying a content provider corresponding to the content identification information based on the content identification information, the time information and the content schedule information, and obtaining the content schedule information corresponding to the identified content provider among the pre-stored information.

Meanwhile, the methods according to the various embodiments may be implemented in the form of an application installable in the existing electronic apparatus.

The methods according to the above-described various embodiments may be implemented only with software upgrade or hardware upgrade regarding the existing electronic apparatus.

The above-described various embodiments may be performed through an imbedded server in an electronic apparatus or an external server of an electronic apparatus.

Meanwhile, the controlling method of an electronic apparatus according to the above described embodiments may be implemented as a program and provided to an electronic apparatus. In particular, a program including the controlling method of an electronic apparatus may be stored in a non-transitory computer readable medium and provided.

The above-described various embodiments may be embodied in an apparatus readable by a computer or a similar device using software, hardware or combination thereof. According to hardware embodiment, the embodiments of the disclosure may be implemented using one of application specific integrated circuits (ASICs), DSPs, digital signal processing devices (DSPDs), programmable logic devices (PLDs), FPGAs, processors, controllers, micro-controllers, microprocessors, and electric units for perform other functions. In some cases, the embodiments described in the disclosure may be implemented as the processor 120 itself. According to software embodiment, the various embodiments such as the procedures and functions described in the disclosure may be implemented as separate software modules. Each of the software modules may perform one or more functions and operations described in the disclosure.

Meanwhile, computer instructions for performing the processing operations in an electronic apparatus according to the above-described various embodiments of the disclosure may be stored in a non-transitory computer-readable medium. The computer instructions, stored in such a non-transitory computer-readable medium, cause a specific apparatus to perform the processing operations in an electronic apparatus according to the above-described various embodiments, based on the computer instructions being executed by the processor of the specific apparatus.

The non-transitory computer-readable medium refers to a medium which may store data semi-permanently rather than storing data for a short time, such as register, cache, memory, etc. and is readable by an apparatus. The non-transitory computer-readable medium includes compact disc (CD), digital versatile disc (DVD), hard disk, Blu-ray disk, USB, memory card, read only memory (ROM), etc.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a memory configured to store content schedule information for each content provider;
a transceiver; and
a processor configured to:
receive content identification information from an external apparatus and time information regarding a time when the content identification information is obtained through the transceiver,
identify a content provider corresponding to the content identification information based on the content identification information, the time information and the content schedule information, and
obtain content schedule information corresponding to the identified content provider from the memory and provide the content schedule information to the external apparatus.

2. The apparatus as claimed in claim 1, wherein the processor is further configured to:
based on receiving first content identification information and first time information regarding a time when the first content identification information is obtained, store a content provider list including a plurality of content providers corresponding to the first content identification information based on the first content identification information, the first time information and the content schedule information, and
based on receiving second content identification information and second time information regarding a time when the second content identification information is obtained, remove a content provider which does not correspond to the second content identification information from the content provider list based on the second content identification information, the second time information, and the content schedule information.

3. The apparatus as claimed in claim 1, wherein the content identification information includes at least one of keyword information obtained from a content, program name information obtained from the content or channel information obtained from the content.

4. The apparatus as claimed in claim 1, wherein the processor is further configured to:
obtain program identification information based on the content identification information;
identify content schedule information corresponding to the content identification information and the time information from among content schedule information stored in the memory; and
identify a content provider corresponding to the content schedule information as a content provider corresponding to the content identification information.

5. The apparatus as claimed in claim 1, wherein the processor is further configured to:
match identification information of the external apparatus to identification information of the content provider and store the matching information in the memory; and
based on receiving a content schedule information request signal from the external apparatus, provide the external apparatus with content schedule information corresponding to the content provider based on the identification information of the matching content provider.

6. The apparatus as claimed in claim 5,
wherein the memory is configured to store at least one of apparatus update information or environment setting information for each of the content provider, and
wherein the processor is further configured to provide the external apparatus with at least one of update information or environment setting information corresponding to the content provider corresponding to identification information of the external apparatus.

7. The apparatus as claimed in claim 1, wherein the processor is further configured to:
based on identification information of a content provider matching identification information of the external apparatus not being stored in the memory, request the external apparatus for the content identification information and time information regarding a time based on the content identification information being obtained.

8. The apparatus as claimed in claim 1, wherein the content identification information is obtained by analyzing an image signal which is input at the external apparatus through at least one of optical character recognition (OCR) or automatic content recognition (ACR).

9. The apparatus as claimed in claim 1,
wherein the external apparatus is a display apparatus, and
wherein the content provider is a provider of an image providing apparatus which provides a content to the display apparatus.

10. A method for controlling an electronic apparatus which stores content schedule information for each content provider, the method comprising:
receiving content identification information and time information regarding a time when the content identification information is obtained from an external apparatus;
identifying a content provider corresponding to the content identification information based on the content identification information, the time information and the content schedule information; and
obtaining content schedule information corresponding to the identified content provider from pre-stored identification information and providing the content schedule information to the external apparatus.

11. The method as claimed in claim 10, wherein the identifying of the content provider comprises:
based on receiving first content identification information and first time information regarding a time when the first content identification information is obtained, storing a content provider list including a plurality of content providers corresponding to the first content identification information based on the first content identification information, the first time information and the content schedule information; and
based on receiving second content identification information and second time information regarding a time when the second content identification information is obtained, removing a content provider which does not correspond to the second content identification information from the content provider list based on the second content identification information, the second time information and the content schedule information.

12. The method as claimed in claim 10, wherein the content identification information includes at least one of keyword information obtained from a content, program name information obtained from the content, or channel information obtained from the content.

13. The method as claimed in claim 10, wherein the identifying of the content provider comprises:
obtaining program identification information based on the content identification information;
identifying content schedule information corresponding to the content identification information and the time information from pre-stored content schedule information; and
identifying a content provider corresponding to the content schedule information as a content provider corresponding to the content identification information.

14. The method as claimed in claim 10, further comprising:
matching identification information of the external apparatus to identification information of the content provider and storing the matching information; and
based on receiving a content schedule information request signal from the external apparatus, providing the external apparatus with content schedule information corresponding to the content provider based on the identification information of the matching content provider.

15. The method as claimed in claim 14, wherein the providing to the external apparatus comprises providing the external apparatus with at least one of update information or environment setting information corresponding to the content provider corresponding to identification information of the external apparatus.

16. The method as claimed in claim 10, further comprising:
based on identification information of a content provider matching identification information of the external apparatus not being pre-stored, requesting the external apparatus for the content identification information and time information regarding a time when the content identification information is obtained.

17. The method as claimed in claim 10, wherein the content identification information is obtained by analyzing an image signal which is input at the external apparatus through at least one of optical character recognition (OCR) or automatic content recognition (ACR).

18. The method as claimed in claim 10,
wherein the external apparatus is a display apparatus, and
wherein the content provider is a provider of an image providing apparatus which provides a content to the display apparatus.

19. A non-transitory computer readable recording medium storing a computer instruction to perform an operation of an electronic apparatus based on being executed by a processor, the electronic apparatus storing content schedule information for each content, the operation comprising:
receiving content identification information and time information regarding a time when the content identification information is obtained from an external apparatus;
identifying a content provider corresponding to the content identification information based on the content identification information, the time information and the content schedule information; and
obtaining content schedule information corresponding to the identified content provider from pre-stored identification information.
